(19) United States
(12) Patent Application Publication
(10) Pub. No.: US 2016/0275603 A1
(43) Pub. Date: Sep. 22, 2016

(54) SERVICE PROCESSING METHOD, DEVICE, AND TERMINAL

(71) Applicant: Tencent Technology (Shenzhen) Company Limited, Shenzhen (CN)

(72) Inventor: Xianhua SU, Shenzhen (CN)

(73) Assignee: Tencent Technology (Shenzhen) Company Limited, Shenzhen (CN)

(21) Appl. No.: 15/169,334

(22) Filed: May 31, 2016

Related U.S. Application Data
(63) Continuation of application No. PCT/CN2014/095175, filed on Dec. 26, 2014.

(30) Foreign Application Priority Data
Dec. 31, 2013 (CN) 201310754729.3

(51) Int. Cl. G06Q 40/02; G06F 17/30; G06Q 20/40

(52) U.S. Cl. CPC G06Q 40/02; G06Q 20/40; G06F 17/30424

(57) ABSTRACT

A service processing method, device, and terminal, are provided, comprising obtaining a first service processing request sent by the first terminal, the first service processing request including at least operation object information, an account password of the first account needing a value update, and a first value; querying a service identifier bound with the operation object information in the first service processing request and querying a first account identifier corresponding to the service identifier bound with the operation object information; obtaining first account information based on the first account identifier, and updating the value of the first account based on the first account information, the account password of the first account, and the first value. The present disclosure queries a first account identifier corresponding to the service identifier bound with the operation object information, obtains first account information based on the first account identifier, and completes the service processing by using only one operation object based on the first account information, password, and a first value, leading to improved processing efficiency and reduced costs.

### CROSS-REFERENCE TO RELATED APPLICATIONS

This application is a continuation out of PCT Application No. PCT/CN2014/095175, filed on Dec. 26, 2014, which claims priority to Chinese Patent Application No. 201310754729.3, filed on Dec. 31, 2013, both of which are hereby incorporated by reference in their entirety.

### FIELD

The present disclosure relates to the field of information technology, particularly to a service processing method, device, and terminal.

### BACKGROUND

With the development of information technologies, more and more types of services based on information technologies have emerged and an increasing number of service processing methods have also become available. Such services include the payment services and recharging services. The amounts of time required for processing such services directly influence user experience.

In the prior art, physical operation objects like bank cards are configured to process services such as payment and recharging. As another type of physical operation objects different from bank cards, membership cards have been more and more commonly used for payment and recharging. As identification cards, membership cards are used for member identification in places of consumption. With membership cards, buyers can enjoy favorable terms such as discounts and credits. Sellers can use membership cards to implement functions such as user management. During the processing of a service, for example, payment, in addition to the card number and password of a bank card, the card number and password of the corresponding membership card are obtained. Thus, the processing of a service, for example, payment, is implemented by using a membership card and a bank card.

During the implementation of the present disclosure, the inventor has found that the existing art has at least the following problems:

As a bank card and a membership card are two different physical cards, two physical cards are required for completing service processing. Such a service processing method causes inconveniences to users. Moreover, issuance of physical membership cards increases costs. In addition, as information needs to be obtained from two types of physical cards respectively during service processing to complete the processing of consumption services, the efficiency of service processing is not high.

### SUMMARY

To solve the problems with the existing art, the embodiments of the present disclosure provide a service processing method, device, and terminal.

In a first aspect, a service processing method is provided. The method includes: obtaining the first service processing request sent by the first terminal, the first service processing request including at least the operation object information, the account password of the first account, and the first value; querying the service identifier bound with the operation object information included in the first service processing request, and querying the first account identifier corresponding to the service identifier bound with the operation object information; obtaining the first account information based on the first account identifier, and updating the value of the first account based on the first account information, the account password of the first account, and the first value.

In a second aspect, a service processing device is provided. The device includes a hardware processor and a non-transitory storage medium accessible to the hardware processor, the non-transitory storage medium configured to store modules. The modules includes: a first acquisition module, configured to obtain the first service processing request sent by the first terminal, the first service processing request including at least the operation object information, the account password of the first account needing a value update, and the first value; a query module, configured to query the service identifier bound with the operation object information included in the first service processing request and query the first account identifier corresponding to the service identifier bound with the operation object information; a processing module, configured to obtain the first account information based on the first account identifier, and update the value of the first account based on the first account information, the account password of the first account, and the first value.

The technical solution provided by the embodiments of the present disclosure has the following benefits:

After querying the first account identifier corresponding to the service identifier bound with the operation object information and obtaining the first account information based on the first account identifier, the present disclosure achieves the service processing based on the first account information, the account password, and the first value. Thus, the service processing is completed by using only one operation object, resulting in improved processing efficiency and reduced costs.

### BRIEF DESCRIPTION OF THE DRAWINGS

To more clearly describe the technical solution provided by the embodiments of the present disclosure, the following gives an overview of the drawings needed to describe the embodiments. Obviously, the following drawings show only some of the embodiments of the present disclosure, and those of ordinary skill in existing art can obtain other drawings based on these drawings without creative work.

FIG. 1 shows an example flowchart of the first service processing method provided by embodiments of the present disclosure.

FIG. 2 shows an example flowchart of the second service processing method provided by embodiments of the present disclosure.

FIG. 3 shows an example flowchart of the third service processing method provided by embodiments of the present disclosure.

FIG. 4 shows an example flowchart of the service processing method provided by embodiments of the present disclosure.

FIG. 5 shows an example schematic diagram of the interaction flowchart provided by embodiments of the present disclosure.

FIG. 6 shows an example flowchart of the service processing method provided by embodiments of the present disclosure.

FIG. 7 shows an example schematic diagram of the interaction flow chart provided by embodiments of the present disclosure.

FIG. 8 shows an example flowchart of the service processing method provided by embodiments of the present disclosure.

FIG. 9 shows an example schematic diagram of the first interaction flow provided by embodiments of the present disclosure.

FIG. 10 shows an example schematic diagram of the second interaction flow provided by embodiments of the present disclosure.

FIG. 11 shows an example structural diagram of the first service processing device provided by embodiments of the present disclosure.

FIG. 12 shows an example structural diagram of the second service processing device provided by embodiments of the present disclosure.

FIG. 13 shows an example structural diagram of the third service processing device provided by embodiments of the present disclosure.

FIG. 14 shows an example structural diagram of the fourth service processing device provided by embodiments of the present disclosure.

FIG. 15 shows an example structural diagram of a server provided by embodiments of the present disclosure.

FIG. 16 shows an example structural diagram of a terminal provided by embodiments of the present disclosure.

FIG. 17 shows an example structural diagram of a terminal provided by embodiments of the present disclosure.

FIG. 18 shows an example structural diagram of a system provided by embodiments of the present disclosure.

### DETAILED DESCRIPTION OF THE DRAWINGS

Reference throughout this specification to “one embodiment,” “an embodiment,” “example embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an example embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the disclosure herein is for the purpose of describing particular examples only and is not intended to be limiting of the disclosure. As used in the description of the disclosure and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “module” or “unit” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module or unit may include memory (shared, dedicated, or group) that stores code executed by the processor.

The exemplary environment may include a server, a client, and a communication network. The server and the client may be coupled through the communication network for information exchange, such as sending/receiving identification information, sending/receiving data files such as splash screen images, etc. Although only one client and one server are shown in the environment, any number of terminals or servers may be included, and other devices may also be included.

The communication network may include any appropriate type of communication network for providing network connections to the server and client or among multiple servers or clients. For example, communication network may include the Internet or other types of computer networks or telecommunication networks, either wired or wireless. In a certain embodiment, the disclosed methods and apparatus may be implemented, for example, in a wireless network that includes at least one client.

In some cases, the client may refer to any appropriate user terminal with certain computing capabilities, such as a personal computer (PC), a work station computer, a server computer, a hand-held computing device (tablet), a smart phone or mobile phone, or any other user-side computing device. In various embodiments, the client may include a network access device. The client may be stationary or mobile.

A server, as used herein, may refer to one or more server computers configured to provide certain server functionalities, such as database management and search engines. A server may also include one or more processors to execute computer programs in parallel.

The solutions in the embodiments of the present disclosure are clearly and completely described in combination with the attached drawings in the embodiments of the present disclosure. Obviously, the described embodiments are only a part, but not all, of the embodiments of the present disclosure. On the basis of the embodiments of the present disclosure, all other embodiments acquired by those of ordinary skill in the art under the precondition that no creative efforts have been made shall be covered by the protective scope of the present disclosure.

In conjunction with the drawings provided in embodiments of the present disclosure, the following section clearly and comprehensively describes the technical solution provided by embodiments of the present disclosure. Obviously, the described embodiments are only some but not all of the embodiments of the present disclosure. All other embodiments that a person skilled in the art derives from the embodiments of the present disclosure without creative work fall within the claims of the present disclosure.

To make clearer the purpose, technical solution, and benefits of the present disclosure, the following describes in further details the embodiments of the present disclosure in conjunction with drawings.

The embodiments provide a service processing method. As shown in FIG. 1, the method provided by this embodiment may include the following steps:

101: Obtain a first service processing request sent by a first terminal, the first service processing request including at least operation object information, an account password of the first account needing a value update and a first value;

102: Query a service identifier bound with the operation object information included in the first service processing request, and query a first account identifier corresponding to the service identifier bound with the operation object information;

As an optional embodiment, before querying the service identifier bound with the operation object information included in the first service processing request, and querying the first account identifier corresponding to the service identifier bound with the operation object information, the following operations are further performed:

Pre-establishing and storing a binding relationship between the operation object information and service identifier and a correspondence between the service identifier and the first account identifier;

Querying the service identifier bound with the operation object information included in the first service processing request, and querying the first account identifier corresponding to the service identifier bound with the operation object information, including, but not limited to,

determining the service identifier bound with the operation object information included in the first service processing request based on the binding relationship between the operation object information and service identifier, and querying the first account identifier corresponding to the service identifier based on the correspondence between the service identifier and first account identifier.

103: Obtain the first account information based on the first account identifier, and update the balance value of the first account based on the first account information, the account password of the first account, and the first value.

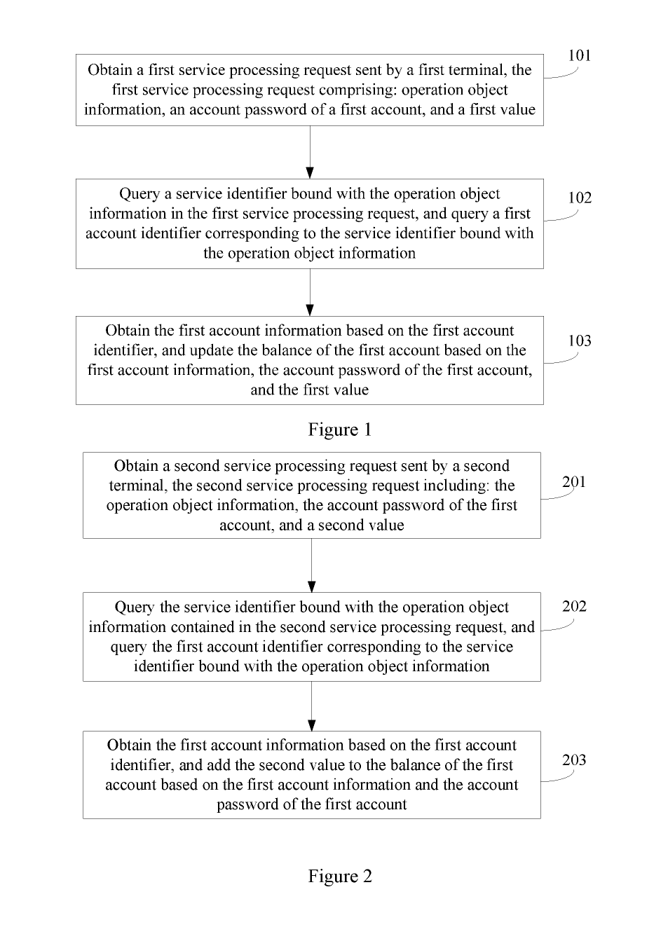

As an optional embodiment, for the above-mentioned service processing method, as shown in FIG. 2, the method provided by this embodiment further includes the following steps:

201: Obtain a second service processing request sent by a second terminal, the second service processing request including at least the operation object information, the account password of the first account, and a second value;

202: Query the service identifier bound with the operation object information included in the second service processing request, and query the first account identifier corresponding to the service identifier bound with the operation object information;

203: Obtain the first account information based on the first account identifier, and add the second value to the balance value of the first account based on the first account information and the account password of the first account.

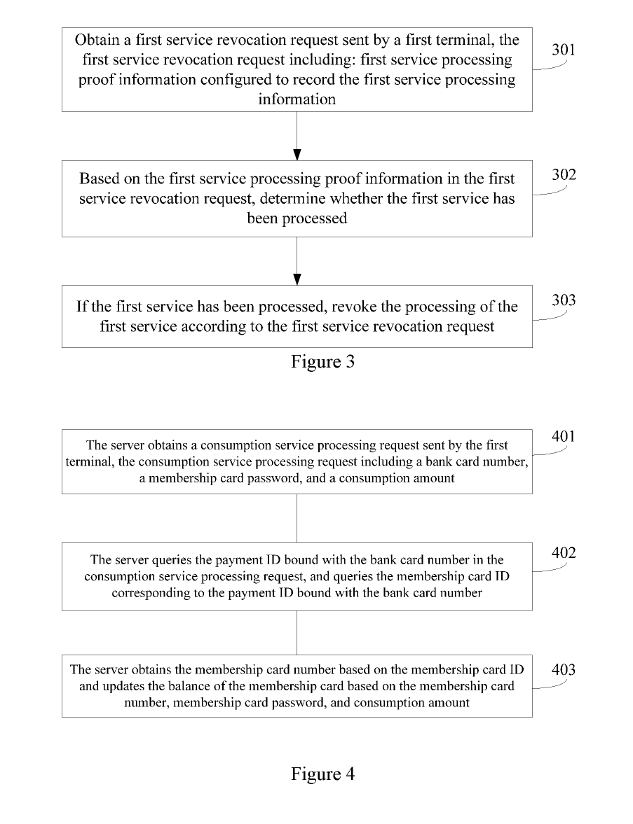

As an optional embodiment, for the above-mentioned service processing method, as shown in FIG. 3, the method provided by this embodiment, after obtaining the first service processing request sent by the first terminal, further includes the following steps:

301: Obtain a first service revocation request sent by the first terminal, the first service revocation request including at least first service processing proof information configured to record the first service processing information;

302: Based on the first service processing proof information included in the first service revocation request, determine whether the first service has been processed;

303: If the first service has been processed, revoke the processing of the first service according to the first service revocation request.

As an optional embodiment, the first service revocation request further includes the operation object information, the account password of the first account, and the first value.

Revoking the processing of the first service according to the first service revocation request includes:

querying the service identifier bound with the operation object information included in the first service revocation request, and querying the first account identifier corresponding to the service identifier bound with the operation object information;

obtaining the first account information based on the first account identifier, and revoking the updating of the value of the first account based on the first account information, the account password of the first account, and the first value.

The method provided by this embodiment is configured to query the first account identifier corresponding to the service identifier bound with the operation object information, obtain the first account information based on the first account identifier, and complete the service processing based on the first account information, the account password, and the first value. Thus, the service processing is completed by using only one operation object, resulting in improved processing efficiency and reduced costs.

The embodiments provide a service processing method. For the service processing method as shown in FIG. 1, the service processing method provided by the above-mentioned embodiment is described in detail, assuming that the processed service is a consumption service; the device that processes the consumption service is a server; the first service processing request is a consumption service request, the operation object is a bank card number; the first account needing a value update is the membership card required for service consumption; the account password of the first account needing a value update is the membership card password; the first value is the consumption amount; the service identifier is the payment ID (identifier); the first account identifier is the membership card ID; and the first account information is the membership card number. The membership card can be one that a user, after logging in to a social networking application supporting payment, obtains by showing interest in a merchant using that application. This embodiment does not limit the merchant type or membership card type. Different from a membership card provided using the existing art, a membership card provided by this embodiment is a virtual card, but not a physical card, expanding the service processing method in a virtual manner and improving customer loyalty.

In conjunction with the contents of the above-mentioned, the following describes in detail the service processing method provided by this embodiment. As shown in FIG. 4, the method provided by this embodiment includes the following steps:

401: The server obtains a consumption service processing request sent by the first terminal, the consumption service processing request including at least a bank card number, membership card password, and consumption amount.

The first terminal can be any terminal with the card swiping function. For example, the first terminal can be a Point of Sale (POS) terminal, which is configured to send consumption service requests by means of offline card swiping; the first terminal can also be any terminal capable of sending requests, such as a mobile phone and a tablet PC, which can send consumption service requests by means of online payment. This embodiment does not limit the specific product form of the first terminal.

To facilitate understanding, the following describes the flow assuming that the first terminal is a POS terminal. The server obtains a consumption service request sent by the POS terminal, the consumption service request including the bank card number A, membership card password B1, and consumption amount 100.

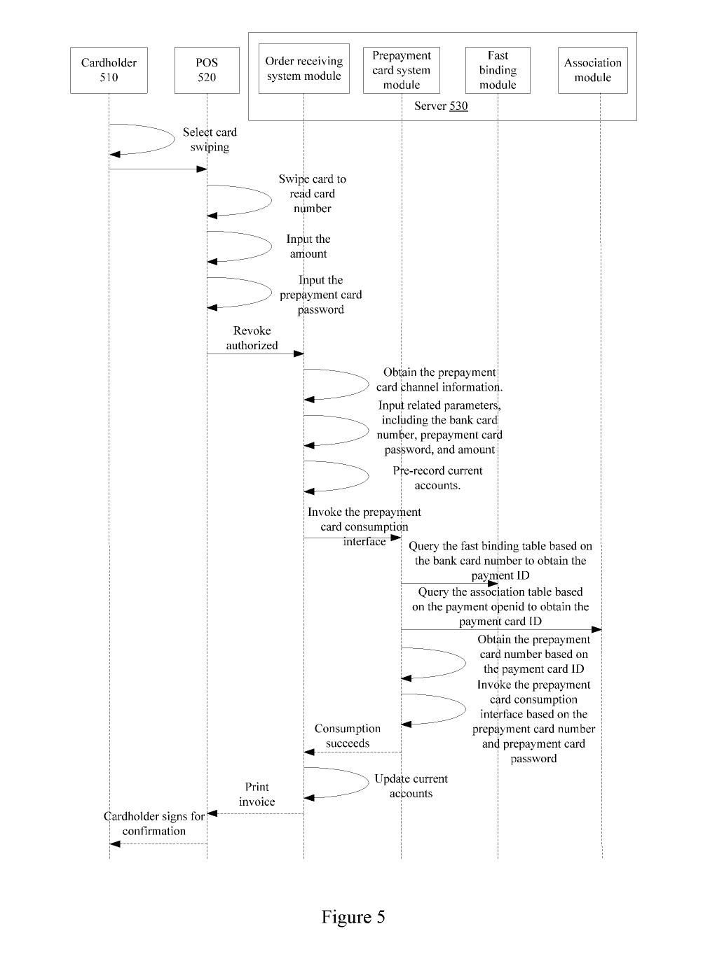

In addition, an example of the service processing interaction flowchart is shown in FIG. 5. The flowchart is implemented in a system that includes a cardholder 510 using a terminal device, a POS terminal 520, and a server 530. The system performs the cardholder operations, POS terminal operations, operations of the order receiving system module, operations of the prepayment card system module, operations of the fast binding module, and operations of the association module. The operations performed in step 401 correspond to the flowchart as shown in FIG. 5, where the POS terminal performs consumption authorization on the order receiving system module; the order receiving system module obtains the prepayment card channel information; the order receiving system module inputs relevant parameters; and the order receiving system module keeps accounts. The functions performed by the order receiving system module, prepayment card system module, fast binding module, and association module are all the service processing functions implemented by the server.

402: The server queries the payment ID (identifier) bound with the bank card number included in the consumption service processing request, and queries the membership card ID corresponding to the payment ID bound with the bank card number.

This embodiment does not limit the specific method configured to query the payment ID (identifier) bound with the bank card number included in the consumption service processing request or the method configured to query the membership card ID corresponding to the payment ID bound with the bank card number. In actual implementation, a binding relationship between a bank card number and a payment ID and a correspondence between a payment ID and a membership card ID can be established and stored in advance. The server's querying the payment ID (identifier) bound with the bank card number included in the consumption service request and querying the membership card ID corresponding to the payment ID bound with the bank card number includes, but is not limited to, determining the payment ID bound with the bank card number based on the binding relationship between the bank card number and payment ID, and querying the membership card ID based on the correspondence between the payment ID and membership card ID.

The payment ID is the account identifier corresponding to the application program installed on the second terminal. For example, the payment ID can be the account name of the application program; the membership card ID can be a membership card number identifier.

Note that a payment ID can be bound with multiple bank card numbers and correspond to multiple membership card IDs. Therefore, association of multiple bank card numbers with multiple membership card IDs can be achieved by using only one payment ID.

In the case a payment ID corresponds to multiple membership card IDs, as each membership card ID corresponds to different membership card passwords, a membership card ID can be queried based on the payment ID and membership card password.

For ease of understanding, assume that the bank card number A and payment ID are the account name C of the application program and that the membership card ID is the membership card number identifier B. In this case, a binding relationship is established between the bank card number A and the account name C; a correspondence is established between the account name C and membership card number identifier B; and the binding relationship and correspondence are stored.

The obtained consumption service processing request includes the bank card number, which is A. Thus, the account name C bound with the bank card number A is determined based on the binding relationship between the bank card number A and account name C; the membership card number identifier B corresponding to the account name C is queried based on the correspondence between the account name C and membership card number identifier B.

In addition, in the service processing interaction flow as shown in FIG. 5, step 402 corresponds to the process where the order receiving system module invokes the prepayment card consumption interface; based on the bank card number, the prepayment card system module queries the fast binding table on the fast binding module to obtain the payment ID; based on the payment ID, the prepayment card system module queries the association table on the association module to obtain the prepayment card ID; the prepayment card system module obtains the prepayment card number based on the prepayment card ID. Here, the prepayment card is the membership card and the prepayment card ID the membership card ID.

403: The server obtains the membership card number based on the membership card ID and updates the balance of the membership card based on the membership card number, membership card password, and consumption amount.

This embodiment does not limit the specific method configured to obtain the membership card number. During actual implementation, the membership card number can be queried based on the correspondence between the membership card ID and membership card number. Methods other than the above-mentioned one can be used.

In addition, the consumption service processing request obtained includes the membership card password. Thus, if the membership card number and the membership card password match, the balance of the membership card is updated.

Specifically, the balance of the membership card is updated, including, but not limited to,

(1) deducting the consumption amount from the balance of the membership card; or (2) deducting the consumption amount from the balance of the bank card, and adding the credits corresponding to the consumption amount to the membership card.

Note that, regardless of whether it is deducted from the balance of the membership card or from the balance of the bank card, the deducted consumption amount is transferred to the service provider's account. Specifically, the server can send the information about the deducted consumption amount to the server corresponding to the service provider's account, and the server corresponding to the service provider's account adds the consumption amount to the balance of the service provider's account.

For ease of understanding, the following describes the flow assuming that the membership card ID is the membership card identifier B; the membership card password is B1; and the consumption amount is 100. As the membership card number B2 corresponds to the membership card number identifier B, the membership card number B2 is obtained based on the membership card number identifier B. After it is determined that the membership card number B2 and membership card password B1 match, the amount 100 is deducted from the balance of the membership card with the card number B2.

For example, assume that a consumption amount of 100 corresponds to 50 credits for the membership card. In this case, the consumption amount 100 is deducted from the balance of the bank card with the card number A, and 50 credits are added to the membership card with the card number B2.

In addition, in the service processing flow as shown in FIG. 5, step 403 corresponds to the process where the prepayment card system module invokes the prepayment card consumption interface based on the prepayment card number and prepayment card password.

The method provided by this embodiment is configured to query the first account identifier corresponding to the service identifier bound with the operation object information, obtain the first account information based on the first account identifier, and complete the service processing based on the first account information and account password. Thus, the service processing is completed by using only one operation object, resulting in improved processing efficiency and reduced costs.

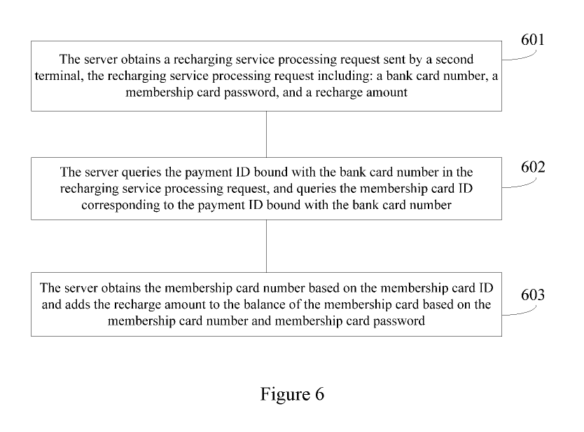

The embodiments provide a service processing method. For the steps of the service processing method as shown in FIG. 2, the service processing method provided by this embodiment is described in detail, assuming that the processed service is the recharging service; the device that processes the recharging service is the server; the second service processing request is a recharging service request; the operation object information is the bank card number; the first account is the recharged membership card; the account password of the first account is the membership card password; the second value is the recharge amount; the service identifier is the membership card ID; the first account identifier is the membership card ID; and the first account information is the membership card number. Combining the contents of the above-mentioned embodiments as shown in FIG. 6, the flow chart of the method provided by this embodiment includes the following steps:

601: The server obtains a recharging service processing request sent by the second terminal, the recharging service processing request including at least a bank card number, membership card password, and recharge amount;

wherein the second terminal can be any terminal capable of sending requests, for example, a mobile phone and tablet PC. This embodiment does not limit the specific product form of the second terminal. Note that the first terminal and the second terminal can be the same terminal.

To facilitate understanding, the following describes the flow assuming that the second terminal is a mobile phone. The server obtains a recharging service request sent by the mobile phone, the recharging service request including the bank card number A, membership card password B1, and recharge amount 100.

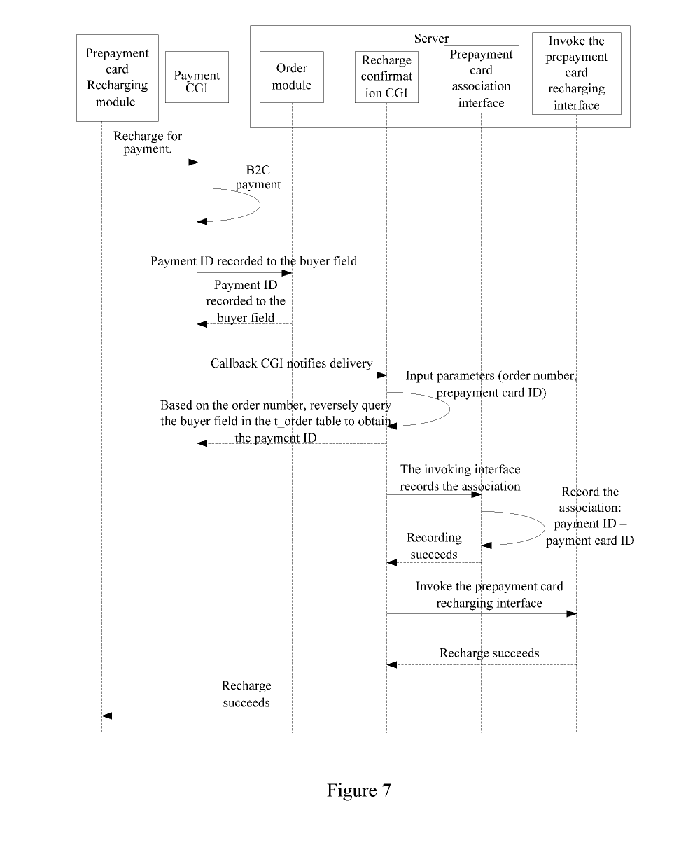

In addition, FIG. 7 shows the service processing interaction flow that includes the prepayment card recharging module, payment Common Gateway Interface (CGI), order module, recharge confirmation CGI, prepayment card association interface, and prepayment card recharging interface. Step 601 corresponds to the flow where the payment CGI records the payment ID to the buyer field; the payment CGI notifies the recharge confirmation CGI of delivery by using the callback CGI; and the recharge confirmation CGI inputs the parameters. The prepayment card recharging module and the payment CGI can be provided on the second terminal. The functions performed by the prepayment card recharging module and the payment CGI can be the functions that the second terminal performs during service processing. The order module, recharge confirmation CGI, prepayment card association interface, and prepayment card recharging interface can be provided on the server. The functions performed by the order module, recharge confirmation CGI, prepayment card association interface, and prepayment card recharging interface are the functions that the server performs during service processing.

602: The server queries the payment ID bound with the bank card number included in the recharging service processing request, and queries the membership card ID corresponding to the payment ID bound with the bank card number.

The actual implementation mode of this step is the same as that of step 402 in the above-mentioned embodiments. For details, see the description of step 402 in embodiments.

In addition, in the service processing interaction flow as shown in FIG. 7, step 6 corresponds to the flow where, based on the order number among the input parameters, the recharge confirmation CGI module reversely queries the buyer field, obtains the payment ID; the invoking interface of the recharge confirmation CGI module records the association; the association interface module of the prepayment card records the association: payment ID-prepayment ID; and the association interface module of the prepayment card returns recording success to the recharge confirmation CGI module.

603: The server obtains the membership card number based on the membership card ID and adds the recharge amount to the balance of the membership card based on the membership card number and membership card password.

This embodiment does not limit the specific method configured to obtain the membership card number. During actual implementation, the membership card number can be queried based on the correspondence between the membership card ID and membership card number. Methods other than the above-mentioned one can be used.

In addition, the consumption service processing request obtained includes the membership card password. Thus, if the membership card number and the membership card password match, the recharge amount is added to the balance of the membership card.

Note that, if the recharge amount needs to be added to the membership card, the recharge amount is deducted from the balance of the bank card. Specifically, the server can send the information about the recharge amount to be deducted to the server corresponding to the bank card; the server corresponding to the bank card deducts the recharge amount from the balance of the bank card.

For ease of understanding, the following describes the flow assuming that the membership card ID is the membership card identifier B; the membership card password is B1; and the recharge amount is 100. As the membership card number B2 corresponds to the membership card number identifier B, the membership card number B2 is obtained based on the membership card number identifier B. After it is determined that the membership card number B2 and membership card password B1 match, the amount 100 is added to the balance of the membership card with the card number B2.

In addition, in the service processing flow as shown in FIG. 7, step 603 corresponds to the flow where the recharge confirmation CGI module performs procedural call on the prepayment card recharge interface module and the prepayment card recharge interface module returns recharge success to the recharge confirmation CGI module.

The method provided by this embodiment is configured to query the first account identifier corresponding to the service identifier bound with the operation object information, obtain the first account information based on the first account identifier, and complete the service processing based on the first account information, the account password, and the first value. Thus, the service processing is completed by using only one operation object, resulting in improved processing efficiency and reduced costs.

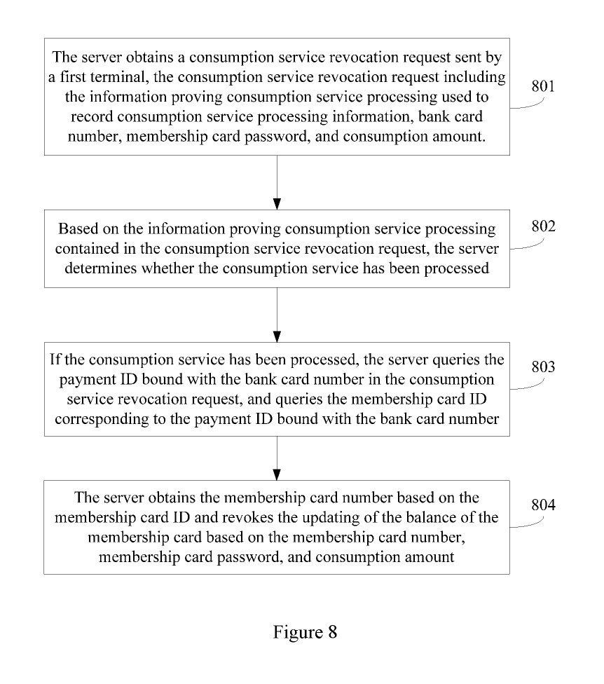

The embodiments provide a service processing method. For the steps of the service processing method as shown in FIG. 3, the service processing method provided by this embodiment is described in detail, assuming that the processed service is the consumption revocation service; the device that processes the consumption revocation service is the server; the first service revocation request is a consumption service revocation request; the operation object information is the bank card number; the first account is the membership card for which consumption is revoked; the account password of the first account is the membership card password; the first value is the consumption amount revoked; the service identifier is the membership card ID (identifier); the first account identifier is the membership card ID; and the first account information is the membership card number. Combining the contents of the above-mentioned embodiments 1 to 3, as shown in FIG. 8, the method provided by this embodiment includes the following steps:

801: The server obtains a consumption service revocation request sent by the first terminal, the consumption service revocation request including at least the information proving consumption service processing configured to record consumption service processing information, bank card number, membership card password, and consumption amount;

wherein the first terminal can be any terminal with the card swiping function, such as a POS terminal and a mobile phone, and the embodiment does not limit the specific product form of the first terminal. The information proving consumption service processing can be the order number of the consumption service, the system reference number of the consumption service, or any other information that identifies the consumption service, not limited by this embodiment.

To facilitate understanding, the following describes the flow assuming that the first terminal is a POS terminal. The server obtains a consumption service request sent by the POS terminal, the consumption service request including the system reference number D1, bank card number A, membership card password B1, and consumption amount 100.

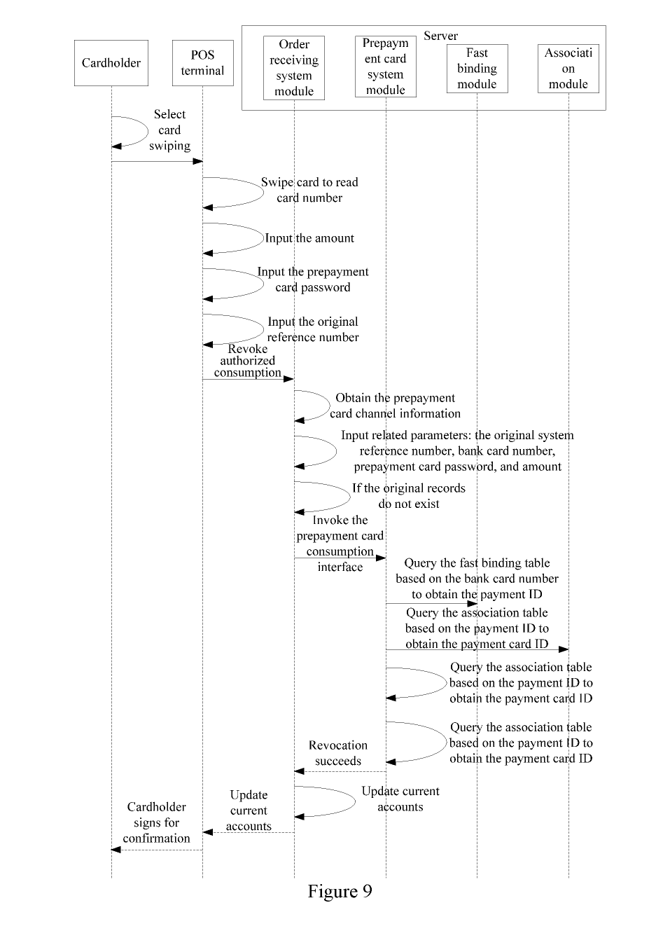

The service processing interaction flow as shown in FIG. 9 includes the cardholder, POS terminal, order receiving system module, prepayment card system module, fast binding module, and association module. The order receiving system module, prepayment card system module, fast binding module, and association module are provided on the server. The functions performed by the order receiving system module, prepayment card system module, fast binding module, and association module are the functions performed by the server during service processing. Step 801 corresponds to the flow where the POS terminal authorizes consumption revocation to the order receiving system module; the order receiving system module obtains the prepayment card channel information; and the order receiving system module inputs related parameters.

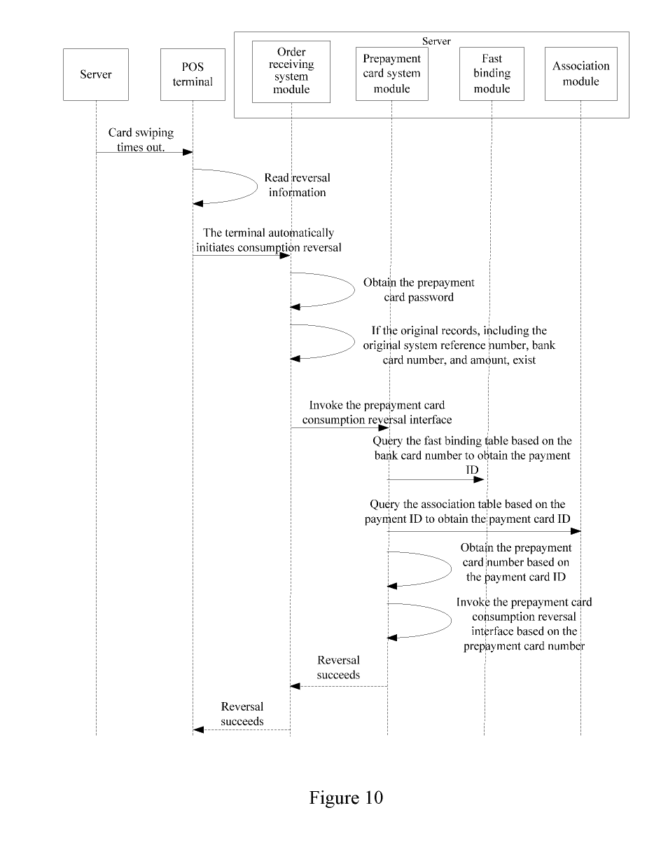

During revocation of a consumption service, the method provided by this embodiment is triggered. In addition, the method provided by this embodiment is also triggered when consumption service processing times out; namely, when consumption reversal occurs. See the service processing interaction flow as shown in FIG. 10. In the case that the consumption service needs to be reversed when the consumption service processing times out, the flow includes, but is not limited to, the following: the POS terminal performs consumption reversal on the order receiving system module; the order receiving system module obtains the prepayment card channel information; the order receiving system module inputs related parameters.

802: Based on the information proving consumption service processing included in the consumption service revocation request, the server determines whether the consumption service has been processed.

This embodiment does not limit the specific method configured to determine whether the consumption service has been processed. During actual implementation, whether the information proving consumption service processing is recorded can be queried. If the information proving consumption service processing is recorded, it can be determined that the consumption service has been processed.

For ease of understanding, the following describes the flow assuming that the information proving consumption service processing is recorded in a list. The list includes information proving consumption service processing D1, D2, D3, and D4. As the consumption service request includes the system reference number D1, the list can be queried to determine that the system reference number D1 is in the list; that is, the consumption service has been processed.

The service processing interaction flow as shown in FIG. 9 includes the cardholder, POS terminal, order receiving system module, prepayment card system module, fast binding module, and association module. Step 802 corresponds to the flow where the order receiving system module determines that the original record exists.

In addition, the service processing interaction flow as shown in FIG. 10 includes the cardholder, POS terminal, order receiving system module, prepayment card system module, fast binding module, and association module. In the case that the consumption service needs to be reversed when the consumption service processing times out, the method provided by this embodiment further includes, but is not limited to, the following: the order receiving system module determines that the original record exists.

803: If the consumption service has been processed, the server queries the payment ID bound with the bank card number included in the consumption service revocation request, and queries the membership card ID corresponding to the payment ID bound with the bank card number.

The actual implementation mode of this step is the same as that of step 402 in the above-mentioned embodiments. For details, see the description of step 402 in embodiments.

In the service processing interaction flow as shown in FIG. 9, step 803 corresponds to the process where the order receiving system module invokes the prepayment card consumption interface; based on the bank card number, the prepayment card system module queries the fast binding table on the fast binding module to obtain the payment ID; based on the payment ID, the prepayment card system module queries the association table on the association module to obtain the prepayment card ID; the prepayment card system module obtains the prepayment card number based on the prepayment card ID.

In addition, the service processing interaction flow as shown in FIG. 10 includes the cardholder, POS terminal, order receiving system module, prepayment card system module, fast binding module, and association module. The order receiving system module, prepayment card system module, fast binding module, and association module are provided on the server. The functions performed by the order receiving system module, prepayment card system module, fast binding module, and association module are the functions performed by the server during service processing. In the case that the consumption service needs to be reversed when the consumption service processing times out, the method provided by this embodiment further includes, but is not limited to, the following: the order receiving system module invokes the prepayment card consumption interface; based on the bank card number, the prepayment card system module queries the fast binding table on the fast binding module to obtain the payment ID; based on the payment ID, the prepayment card system module queries the association table on the association module to obtain the prepayment card ID; the prepayment card system module obtains the prepayment card number based on the prepayment card ID.

804: The server obtains the membership card number based on the membership card ID and revokes the updating of the balance of the membership card based on the membership card number, membership card password, and consumption amount.

The actual implementation mode of obtaining the membership card number is the same as that of step 403 in the above-mentioned embodiments. For details, see the description of step 403 in embodiments.

Further, when the updating of the balance of the membership card is revoked based on the membership card number, membership card password, and consumption amount, if the updating on the balance of the membership card is deducting the consumption amount from the balance of the membership card, deduction of the consumption amount from the balance of the membership card is revoked; namely, the consumption amount is added to the balance of the membership card; if the updating on the balance of the membership card is deducting the consumption amount from the balance of the bank card and adding credits corresponding to the consumption amount to the membership card, deduction of the consumption amount from the balance of the bank card and addition of credits corresponding to the consumption amount to the membership card is revoked; namely, the consumption amount is added to the balance of the bank card, and the credits corresponding to the consumption amount are deducted from the membership card.

Note that the added consumption amount is obtained from the service provider's account. Specifically, the server can send the information about the added consumption amount to the server corresponding to the service provider's account, and the server corresponding to the service provider's account deducts the consumption amount from the balance of the service provider's account.

In the service processing interaction flow as shown in FIG. 9, step 804 corresponds to the process where the prepayment card system module invokes the prepayment card consumption revocation interface based on the prepayment card number and prepayment card password.

In addition, see the service processing interaction flow as shown in FIG. 10. In the case that the consumption service needs to be reversed when the consumption service processing times out, the method provided by this embodiment further includes, but is not limited to, the following: based on the prepayment card number, the prepayment card system module invokes the prepayment card consumption reversal interface.

The method provided by this embodiment is configured to query the first account identifier corresponding to the service identifier bound with the operation object information, obtain the first account information based on the first account identifier, and complete the service processing based on the first account information, the account password, and the first value. Thus, the service processing is completed by using only one operation object, resulting in improved processing efficiency and reduced costs.

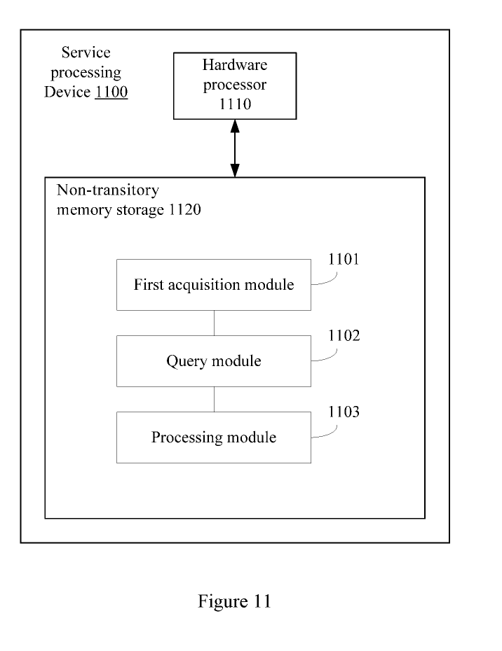

As shown in FIG. 11, the embodiments provide a service processing device 1100. The device 1100 includes a hardware processor 1110 and a non-transitory storage medium 1120 accessible to the hardware processor 1110, the non-transitory storage medium 1120 is configured to store modules. The modules includes:

the first acquisition module 1101, configured to obtain the first service processing request sent by the first terminal, the first service processing request including at least the operation object information, the account password of the first account needing a value update, and the first value;

the query module 1102, configured to query the service identifier bound with the operation object information included in the first service processing request and query the first account identifier corresponding to the service identifier bound with the operation object information;

the processing module 1103, configured to obtain the first account information based on the first account identifier, and update the balance value of the first account based on the first account information, the account password of the first account, and the first value.

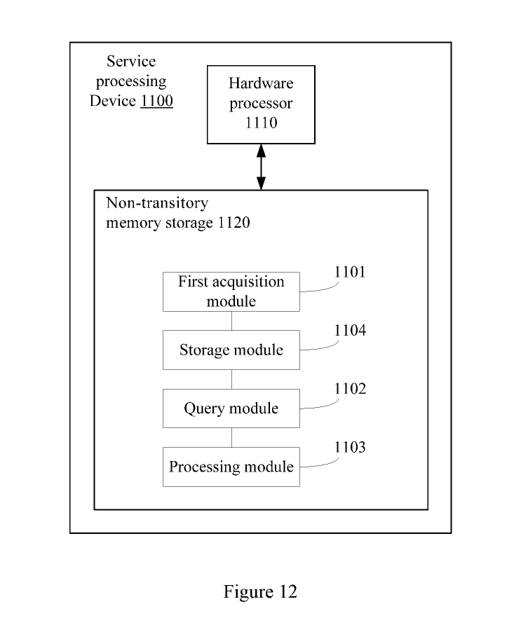

As a preferred embodiment, as shown in FIG. 12, the device further includes:

the storage module 1104, configured to pre-establish and store a binding relationship between the operation object information and service identifier and a correspondence between the service identifier and the first account identifier;

the query module 1102, configured to determine the service identifier bound with the operation object information included in the first service processing request based on the binding relationship between the operation object information and service identifier, and query the first account identifier corresponding to the service identifier based on the correspondence between the service identifier and first account identifier.

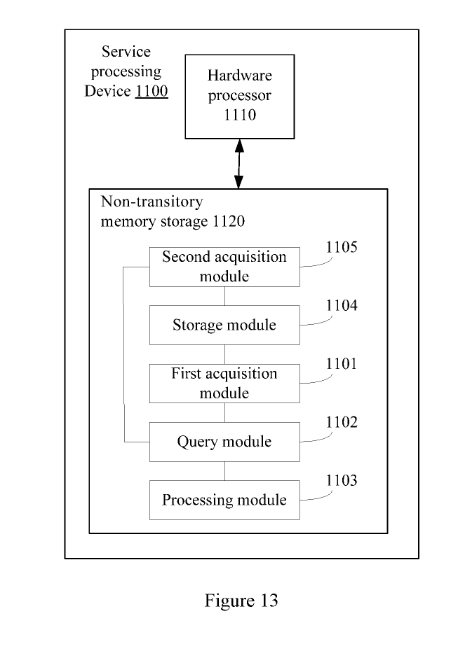

As a preferred embodiment, as shown in FIG. 13, the device further includes:

the second acquisition module 1105, configured to obtain the second service processing request sent by the second terminal, the second service processing request including at least the operation object information, the account password of the first account, and the second value;

the query module 1102, further configured to query the service identifier bound with the operation object information included in the second service processing request and query the first account identifier corresponding to the service identifier bound with the operation object information;

the processing module 1103, further configured to obtain the first account information based on the first account identifier, and add the second value to the balance value of the first account based on the first account information and the account password of the first account.

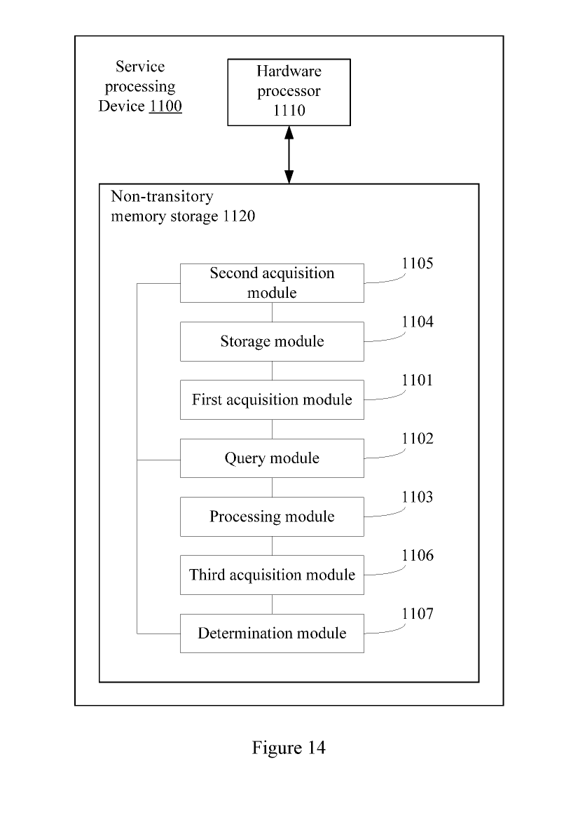

As a preferred embodiment shown in FIG. 14, the device further includes:

the third acquisition module 1106, configured to obtain the first service revocation request sent by the first terminal, the first service revocation request including at least the first service processing proof information configured to record the first service processing information;

the judgment module 1107, configured to, based on the first service processing proof information included in the first service revocation request, determine whether the first service has been processed;

the processing module 1103, further configured to, if the first service has been processed, revoke the processing of the first service according to the first service revocation request.

As a preferred embodiment, the first service revocation request further includes the operation object information, the account password of the first account, and the first value;

the processing module 1103, configured to query the service identifier bound with the operation object information included in the first service revocation request and query the first account identifier corresponding to the service identifier bound with the operation object information; obtain the first account information based on the first account identifier, and revoke the updating of the value of the first account based on the first account information, the account password of the first account, and the first value.

The device provided by this embodiment is configured to query the first account identifier corresponding to the service identifier bound with the operation object information, obtain the first account information based on the first account identifier, and complete the service processing based on the first account information, the account password, and the first value. Thus, the service processing is completed by using only one operation object, resulting in improved processing efficiency and reduced costs.

The devices illustrated in FIGS. 11-14 may be combined to one or more devices. For example, the devices illustrated in any two of the FIGS. 11-14 may be combined to one device.

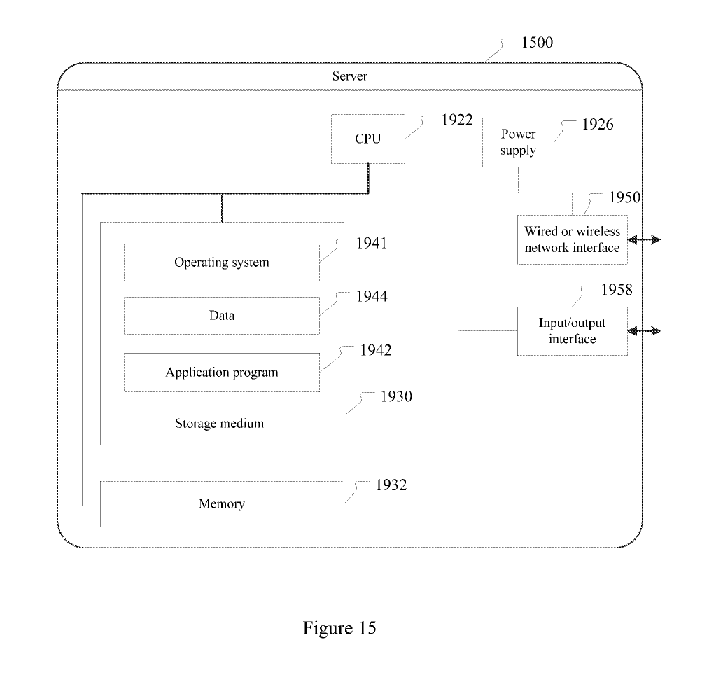

FIG. 15 shows the structural diagram for the server provided by this embodiment. The server 1500 may vary significantly depending on configurations and performance. The server 1500 can comprise one or more central processing units (CPUs) 1922 (for example, one or more processors), the memory 1932, and one or more storage media 1930 (for example, one or more mass storage devices) configured to store the application program 1942 or the data 1944. The memory 1932 and the storage medium 1930 may include non-transitory storage and transitory storage. The program stored on the storage medium 1930 may include one or more modules (not shown in the figure), and each module can comprise a series of instruction operations on the server 1500:

obtaining the first service processing request sent by the first terminal, the first service processing request including at least the operation object information, the account password of the first account needing a value update and the first value;

querying the service identifier bound with the operation object information included in the first service processing request, and querying the first account identifier corresponding to the service identifier bound with the operation object information;

obtaining the first account information based on the first account identifier, and updating the value of the first account based on the first account information, the account password of the first account, and the first value.

In another embodiment, the following instructions are further comprised:

Before querying the service identifier bound with the operation object information included in the first service processing request and querying the first account identifier corresponding to the service identifier bound with the operation object information, the following operations are further performed:

pre-establishing and storing a binding relationship between the operation object information and service identifier and a correspondence between the service identifier and the first account identifier;

querying the service identifier bound with the operation object information included in the first service processing request, and querying the first account identifier corresponding to the service identifier bound with the operation object information, comprising:

determining the service identifier bound with the operation object information included in the first service processing request based on the binding relationship between the operation object information and service identifier, and querying the first account identifier corresponding to the service identifier based on the correspondence between the service identifier and first account identifier.

In another embodiment, the following instructions are further comprised:

obtaining the second service processing request sent by the second terminal, the second service processing request including at least the operation object information, the account password of the first account, and the second value;

querying the service identifier bound with the operation object information included in the second service processing request, and querying the first account identifier corresponding to the service identifier bound with the operation object information;

obtaining the first account information based on the first account identifier, and adding the second value to the value of the first account based on the first account information and the account password of the first account.

In another embodiment, the following instructions are further comprised:

After obtaining the first service processing request sent by the first terminal, the following operations are further performed:

obtaining the first service revocation request sent by the first terminal, the first service revocation request including at least the first service processing proof information configured to record the first service processing information;

based on the first service processing proof information included in the first service revocation request, determining whether the first service has been processed;

if the first service has been processed, revoking the processing of the first service according to the first service revocation request.

In another embodiment, the following instructions are further comprised:

the first service revocation request further including the operation object information, the account password of the first account, and the first value;

revoking the processing of the first service according to the first service revocation request, comprising:

querying the service identifier bound with the operation object information included in the first service revocation request, and querying the first account identifier corresponding to the service identifier bound with the operation object information;

obtaining the first account information based on the first account identifier, and revoking the updating of the value of the first account based on the first account information, the account password of the first account, and the first value.

Further, the CPU 1922 can be configured to communicate with the storage medium 1930 and perform on the server 1500 a series of instruction operations stored in the storage medium 1930.

The server 1500 can further comprise one or more power modules 1926, one or more wired or wireless network interfaces 1950, one or more input/output interfaces 1958, and/or one or more operating systems 1941, such as Windows Server™, Mac OS X™, Unix™, Linux™, and FreeBSD™.

The server provided by this embodiment is configured to query the first account identifier corresponding to the service identifier bound with the operation object information, obtain the first account information based on the first account identifier, and complete the service processing based on the first account information, the account password, and the first value. Thus, the service processing is completed by using only one operation object, resulting in improved processing efficiency and reduced costs.

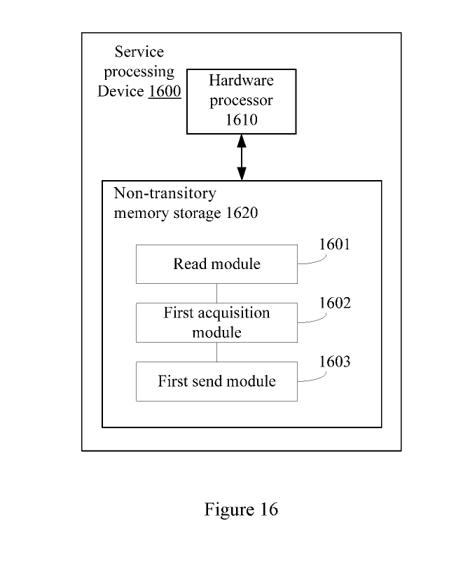

As shown in FIG. 16, a terminal 1600 is provided by this embodiment. The terminal 1600 includes a hardware processor 1610 and a non-transitory storage medium 1620 accessible to the hardware processor 1610, the non-transitory storage medium 1620 is configured to store modules. The modules includes:

the reading module 1601, configured to read the operation object information;

the first acquisition module 1602, configured to obtain the account password of the first account needing a value update, and the first value;

the first sending module 1603, configured to send to the service processing device a first service processing request that carries the operation object information, the account password of the first account, and the first value so that the service processing device processes the first service based on the first service processing request.

As a preferred embodiment, the terminal 1600 further includes:

a second acquisition module, configured to obtain the first service revocation instruction and the first service processing proof information;

a second sending module, configured to, according to the first service revocation instruction, send to the service processing device a first service revocation request that carries the first service processing proof information so that the service processing device revokes the first service based on the first service revocation request.

As a preferred embodiment, the terminal further includes:

a third acquisition module, configured to obtain the operation object information, the account password of the first account, and the first value;

a second sending module configured to, according to the first service revocation instruction, send to the service processing device a first service revocation request that carries the first service processing proof information, the operation object information, the account password of the first account, and the first value.

The terminal provided by this embodiment reads the operation object information, obtains the account password of the first account needing a value update and the first value, and sends to the service processing device a first service processing request that carries the operation object information, the account password of the first account, and the first value so that the service processing device processes the first service based on the first service processing request. Thus, the service processing is completed by using only one operation object, resulting in improved processing efficiency and reduced costs.

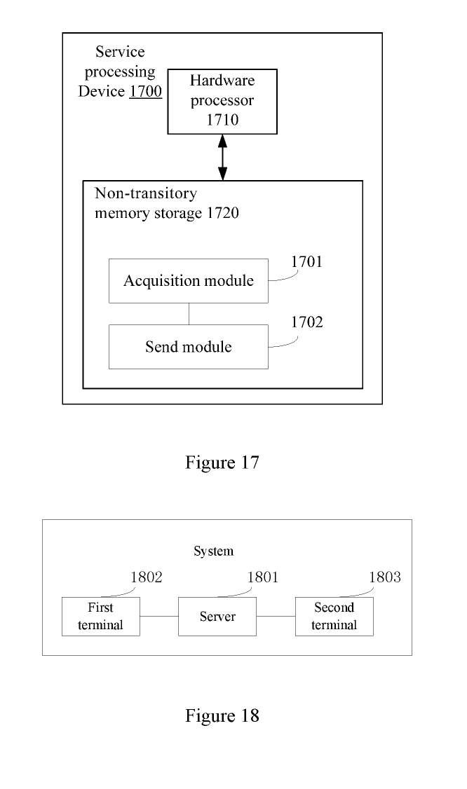

As shown in FIG. 17, a terminal 1700 is provided by this embodiment. The terminal 1700 includes a hardware processor 1710 and a non-transitory storage medium 1720 accessible to the hardware processor 1710, the non-transitory storage medium 1720 is configured to store modules. The modules may include:

the acquisition module 1701, configured to obtain the operation object information, the account password of the first account, and the second value;

the sending module 1702, configured to send to the service processing device a second service processing request that carries the operation object information, the account password of the first account, and the second value so that the service processing device processes the second service based on the second service processing request.

The terminal provided by this embodiment obtains the operation object information, the account password of the first account and the second value, and sends to the service processing device a second service processing request that carries the operation object information, the account password of the first account, and the second value so that the service processing device processes the second service based on the second service processing request. Thus, the service processing is completed by using only one operation object, resulting in improved processing efficiency and reduced costs. The embodiments shown in FIGS. 16 and 17 may be implemented in one terminal device.

As shown in FIG. 18, the embodiments provide a service processing system, comprising the server 1801, the first terminal 1802, and the second terminal 1803;

wherein, the server 1801 is configured to obtain the first service processing request sent by the first terminal 1802, the first service processing request including at least the operation object information, the account password of the first account needing a value update, and the first value; query the service identifier bound with the operation object information included in the first service processing request and query the first account identifier corresponding to the service identifier bound with the operation object information; obtain the first account information based on the first account identifier, and update the balance value of the first account based on the first account information, the account password of the first account, and the first value.

As a preferred embodiment, the server 1801 is further configured to pre-establish and store a binding relationship between the operation object information and service identifier and a correspondence between the service identifier and the first account identifier; determine the service identifier bound with the operation object information included in the first service processing request based on the binding relationship between the operation object information and service identifier, and query the first account identifier corresponding to the service identifier based on the correspondence between the service identifier and the first account identifier.

As a preferred embodiment, the server 1801 is further configured to obtain the second service processing request sent by the second terminal 1803, the second service processing request including at least the operation object information, the account password of the first account, and the second value; query the service identifier bound with the operation object information included in the second service processing request and query the first account identifier corresponding to the service identifier bound with the operation object information; obtain the first account information based on the first account identifier, and add the second value to the balance value of the first account based on the first account information and the account password of the first account.

As a preferred embodiment, the server 1801 is further configured to obtain the first service revocation request sent by the first terminal 1802, the first service revocation request including at least the first service processing proof information configured to record the first service processing information; based on the first service processing proof information included in the first service revocation request, determine whether the first service has been processed; if the first service has been processed, revoke the processing of the first service according to the first service revocation request.

As a preferred embodiment, the first service revocation request further includes the first account information, the account password of the first account, and the first value; the server 1801 is further configured to query the service identifier bound with the operation object information included in the first service revocation request and query the first account identifier corresponding to the service identifier bound with the operation object information; obtain the first account information based on the first account identifier, and cancel the updating of the value of the first account based on the first account information, the account password of the first account, and the first value.

The first terminal 1802 is configured to read the operation object information, obtain the account password of the first account needing a value update and the first value, send to the server 1801 the first service processing request that carries the operation object information, the account password of the first account, and the first value so that the server 1801 processes the first service based on the first service processing request.

As a preferred embodiment, the server 1801 is further configured to obtain the first service revocation instruction and the first service processing proof information; according to the first service revocation instruction, send to the server 1801 the first service revocation request that carries the first service processing proof information so that the server 1801 revokes the first service based on the first service revocation request.

As a preferred embodiment, the first terminal 1802 is further configured to obtain the operation object information, the account password of the first account, and the first value; according to the first service revocation instruction, send to the server 1801 the first service revocation request that carries the first service processing proof information, operation object information, account password of the first account, and the first value.

The second terminal 1803 is configured to obtain the operation object information, the account password of the first account, and the second value, send to the server 1801 the second service processing request that carries the operation object information, the account password of the first account, and the second value so that the server 1801 processes the second service based on the second service processing request.

The system provided by this embodiment is configured to query the first account identifier corresponding to the service identifier bound with the operation object information, obtain the first account information based on the first account identifier, and complete the service processing based on the first account information, the account password, and the first value. Thus, the service processing is completed by using only one operation object, resulting in improved processing efficiency and reduced costs.

Note that, the service processing performed by the service processing device provided by the above-mentioned embodiments is described by using only the division of the above-mentioned function modules as an example. In actual application, the above-mentioned functions can be assigned to different function modules for completion as needed. That is, the internal structure of the device can be divided into different function modules to complete all or some of the above-mentioned functions. In addition, the service processing device, server, and method provided by the above-mentioned embodiments adopt the same concept. For the implementation details, see the description of the method provided by the above-mentioned embodiments.

The sequence numbers of the above-mentioned embodiments are intended only for description, instead of indicating the priorities of the embodiments.

Those of ordinary skill in the existing art can understand that all of or part of the steps described in the above-mentioned embodiments can be completed by hardware or by related hardware as instructed by a program. The program can be stored on a computer-readable storage medium. The storage medium can be a Read-Only Memory (ROM), a magnetic disk, or an optical disk.

While the present disclosure has been particularly disclosed and described above with reference to preferred embodiments, it should be understood that the description is not intended to limit the present disclosure. Any modifications, equivalent substitutions, and improvements made without departing from the spirit or principle of the present disclosure shall fall within the scope of the present disclosure.

1. A method, comprising:
obtaining, by a device comprising a processor, a first service processing request sent by a first terminal, the first service processing request comprising: operation object information, an account password of a first account, and a first value;
querying, by the device, a service identifier bound with the operation object information in the first service processing request, and querying a first account identifier corresponding to the service identifier bound with the operation object information; and
obtaining, by the device, first account information based on the first account identifier, and updating a balance of the first account based on the first account information, the account password of the first account, and the first value.

2. The method according to claim 1, wherein before querying the service identifier bound with the operation object information in the first service processing request and querying of a first account identifier corresponding to the service identifier bound with the operation object information, the method further comprises:
establishing and storing a binding relationship between the operation object information and the service identifier and a correspondence between the service identifier and the first account identifier; and
wherein querying the service identifier bound with the operation object information in the first service processing request and querying a first account identifier corresponding to the service identifier bound with the operation object information comprises: determining the service identifier bound with the operation object information in the first service processing request based on the binding relationship between the operation object information and service identifier, and querying the first account identifier corresponding to the service identifier based on the correspondence between the service identifier and first account identifier.

3. The method according to claim 1, further comprising:
obtaining a second service processing request sent by a second terminal, the second service processing request comprising: the operation object information, the account password of the first account, and a second value;
querying a second service identifier bound with the operation object information in the second service processing request, and querying the first account identifier corresponding to the second service identifier bound with the operation object information; and
obtaining the first account information based on the first account identifier, and adding the second value to the balance of the first account based on the first account information and the account password of the first account.

4. The method according to claim 1, wherein after the obtaining of the first service processing request sent by the first terminal, the method further comprises:
obtaining a first service revocation request sent by the first terminal, the first service revocation request comprising: service processing proof information configured to record first service processing information;
based on the first service processing proof information in the first service revocation request, determining whether the first service has been processed; and
if the first service has been processed, revoking the processing of the first service according to the first service revocation request.

5. The method according to claim 4, wherein the first service revocation request further comprises the operation object information, the account password of the first account, and the first value;
wherein revoking the processing of the first service according to the first service revocation request comprises:
querying the service identifier bound with the operation object information in the first service revocation request, and querying the first account identifier corresponding to the service identifier bound with the operation object information; and
obtaining the first account information based on the first account identifier, and revoking the updating of the value of the first account based on the first account information, the account password of the first account, and the first value.

6. A service processing device, comprising a hardware processor and a non-transitory storage medium accessible to the hardware processor, the non-transitory storage medium configured to store modules comprising:
a first acquisition module, configured to obtain a first service processing request sent by a first terminal, the first service processing request comprising: operation object information, an account password of a first account, and a first value;
a query module, configured to query a service identifier bound with the operation object information in the first service processing request and query a first account identifier corresponding to the service identifier bound with the operation object information; and
a processing module, configured to obtain first account information based on the first account identifier, and update a balance of the first account based on the first account information, the account password of the first account, and the first value.

7. The device according to claim 6, further comprising:
a storage module, configured to pre-establish and store a binding relationship between the operation object information and service identifier and a correspondence between the service identifier and the first account identifier; and
the query module, configured to determine the service identifier bound with the operation object information in the first service processing request based on the binding relationship between the operation object information and service identifier, and query the first account identifier corresponding to the service identifier based on the correspondence between the service identifier and first account identifier.

8. The device according to claim 6, further comprising:
a second acquisition module, configured to obtain a second service processing request sent by a second terminal, the second service processing request comprising at least the operation object information, the account password of the first account, and the second value;
the query module, further configured to query a second service identifier bound with the operation object information in the second service processing request and query the first account identifier corresponding to the second service identifier bound with the operation object information; and
the processing module, further configured to obtain the first account information based on the first account identifier and add the second value to the balance of the first account based on the first account information and the account password of the first account.

9. The device according to claim 6, further comprising:
a third acquisition module, configured to obtain a first service revocation request sent by the first terminal, the first service revocation request comprising: first service processing proof information configured to record the first service processing information;
a judgment module, configured to, based on the first service processing proof information in the first service revocation request, determine whether the first service has been processed; and
the processing module, further configured to, if the first service has been processed, revoke the processing of the first service according to the first service revocation request.

10. The device according to claim 9, wherein the first service revocation request further comprises the operation object information, the account password of the first account, and the first value;
the processing module is configured to query the service identifier bound with the operation object information in the first service revocation request and query the first account identifier corresponding to the service identifier bound with the operation object information; obtain the first account information based on the first account identifier, and revoke the updating of the value of the first account based on the first account information, the account password of the first account, and the first value.

11. A service processing method, comprising:
reading operation object information and obtaining an account password of a first account, and a first value; and
sending to a service processing device a first service processing request that comprises the operation object information, the account password of the first account, and the first value so that the service processing device processes the first service based on the first service processing request.

12. The method according to claim 11, further comprising:
obtaining a first service revocation instruction and the first service processing proof information; and
according to the first service revocation instruction, sending to the service processing device a first service revocation request that comprises the first service processing proof information so that the service processing device revokes the first service based on the first service revocation request.

13. The method according to claim 12, further comprising:
obtaining the operation object information, the account password of the first account, and the first value;
wherein sending to the service processing device the first service revocation request that comprises the first service processing proof information according to the first service revocation instruction further comprises:
according to the first service revocation instruction, sending to the service processing device the first service revocation request that comprises the first service processing proof information, the operation object information, the account password of the first account, and the first value.

14. The method according to claim 11, comprising:
obtaining the operation object information, the account password of the first account, and a second value; and
sending to the service processing device a second service processing request that comprises the operation object information, the account password of the first account, and the second value so that the service processing device processes the second service based on the second service processing request.

15. A terminal, comprising a hardware processor and a non-transitory storage medium accessible to the hardware processor, the non-transitory storage medium configured to store modules comprising:
a reading module, configured to read operation object information;
a first acquisition module, configured to obtain an account password of a first account, and a first value; and
a first sending module, configured to send to a service processing device a first service processing request that comprises the operation object information, the account password of the first account, and the first value so that the service processing device processes the first service based on the first service processing request.

16. The terminal according to claim 15, further comprising:
a second acquisition module, configured to obtain a first service revocation instruction and first service processing proof information; and
a second sending module, configured to, according to the first service revocation instruction, send to the service processing device a first service revocation request that comprises the first service processing proof information so that the service processing device revokes the first service based on the first service revocation request.

17. The terminal according to claim 16, further comprising:
a third acquisition module, configured to obtain the operation object information, the account password of the first account, and the first value; and
the second sending module configured to, according to the first service revocation instruction, send to the service processing device a first service revocation request that comprises the first service processing proof information, the operation object information, the account password of the first account, and the first value.

18. The terminal of claim 15, further comprising:
an acquisition module, configured to obtain the operation object information, the account password of the first account, and a second value; and
a sending module, configured to send to the service processing device a second service processing request that comprises the operation object information, the account password of the first account, and the second value so that the service processing device processes the second service based on the second service processing request.
